(19) United States
(12) Patent Application Publication
(10) Pub. No.: US 2009/0161129 A1
(43) Pub. Date: Jun. 25, 2009

(54) Used Media Printing

(75) Inventors: Toh Cher Lek, Choa Chu Kang Crescent (SG); Sandeep Kumar Arya, Northvale (SG); Pang Chern Sing, Pasir Ris Dr 4 (SG)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/962,843

(22) Filed: Dec. 21, 2007

(51) Int. Cl. G06K 15/00

(52) U.S. Cl. 358/1.9; 358/471

(57) ABSTRACT

A printing device includes a used media holder. A scan module is operable to receive a piece of used media from the used media holder and determine whether the piece of used media includes a printable side. A print module is operable to receive the piece of used media from the scan module and, in response to the scan module determining that the piece of used media comprises a printable side, the print module is operable to print on the printable side.

### BACKGROUND

The present disclosure relates generally to information handling systems, and more particularly to a printing device that may be coupled to an information handling system and used to print on used media.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Printing devices may be coupled to IHSs in order to print, for example, documents, images, photographs, and/or a variety of other files known in the art that may exist on the IHS. The printing device may print on a variety of different media known in the art such as, for example, 8×11 paper, A4 paper, and/or photo paper. The waste of such used media may raise a number of issues. For example, in many business situations, substantial waste of used media may occur when the used media is discarded as, after the printing, there will typically be a printed side and an unprinted side on the used media.

Conventionally, the waste of such print media may be dealt with by hand-sorting all of the used media such that the unprinted side of each piece of used media faces the same direction. The hand-sorted used media may then be placed in a printing device such that the printing device prints on the unprinted side of the used media. However, such a solution is time and labor intensive and prone to errors that may result in the waste of printing material when a previously printed side of the used media is printed upon. Such problems discourage the use, and encourage the waste, of used media.

Accordingly, it would be desirable to provide for improved used media printing.

### SUMMARY

According to one embodiment, a printing device includes a used media holder, a scan module that is operable to receive a piece of used media from the used media holder and determine whether the piece of used media comprises a printable side, and a print module that is operable to receive the piece of used media from the scan module, wherein in response to the scan module determining that the piece of used media comprises a printable side, the print module is operable to print on the printable side.

### BRIEF DESCRIPTION OF THE DRAWINGS

FIG. 1 is a schematic view illustrating an embodiment of an IHS.

FIG. 2 is a schematic view illustrating an embodiment of a printing device.

FIG. 3a is a flow chart illustrating an embodiment of a method for used media printing.

FIG. 3b is a schematic view illustrating an embodiment of used media moving on a scan path.

FIG. 3c is a front view of a first or second side of a piece of used media.

FIG. 3d is a front view of a first or second side of a piece of used media.

FIG. 3e is a schematic view illustrating an embodiment of used media moving from a scan path to a print path.

FIG. 3f is a schematic view illustrating an embodiment of used media moving on a print path.

FIG. 3g is a schematic view illustrating an embodiment of used media moving from a scan path to a duplexing path.

FIG. 3h is a schematic view illustrating an embodiment of used media moving from a duplexing path to a scan path.

FIG. 3i is a schematic view illustrating an embodiment of used media moving from a scan path to a rejected media path.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

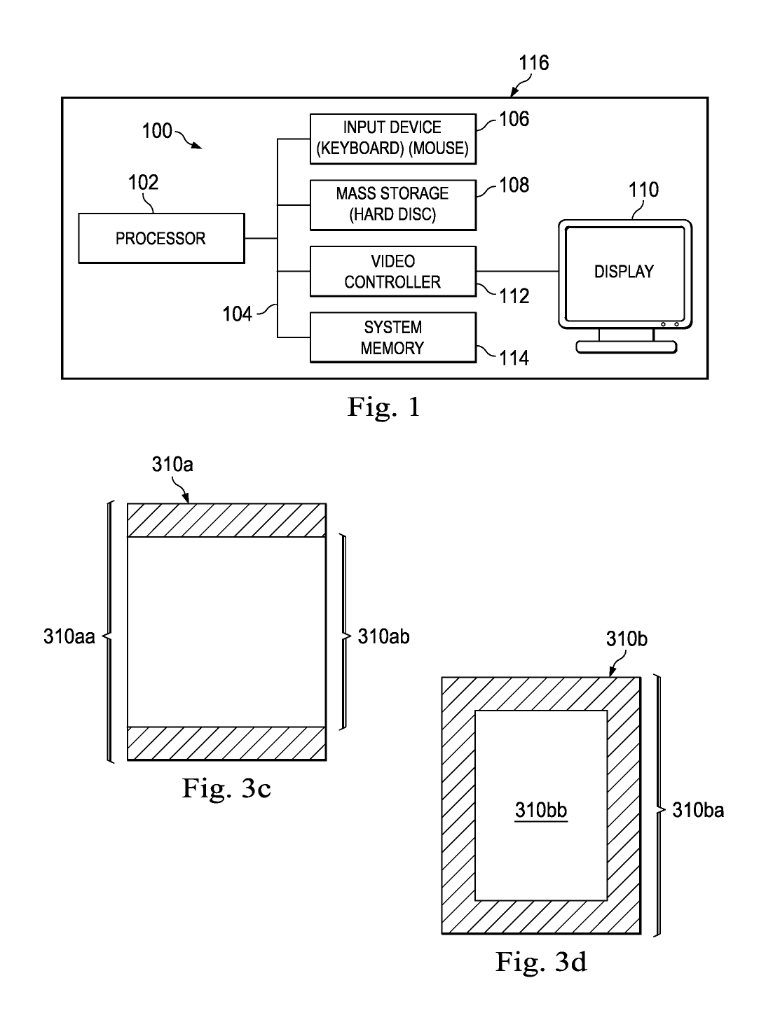

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

Referring now to FIG. 2, a printing device 200 is illustrated. In an embodiment, the printing device 200 may be coupled to the IHS 100, described above with reference to FIG. 1, such that components of the printing device 200 are coupled to, for example, the processor 102, the input device 106, the mass storage 108, the system memory 114, and/or a variety of other IHS components known in the art. In an embodiment, the printing device 200 is a standalone printer that is not coupled to an IHS. In an embodiment, the printing device 200 may also be an IHS, similar to the IHS 100, and may include some or all of the components of an IHS such as, for example, a processor, input devices, mass storage, a display, a video controller, a system memory, and/or a variety of other IHS components known in the art. In an embodiment, the printing device 200 may be a an ink-jet printer, a bubble-jet printer, a laser printer, a Liquid Crystal Display (LCD) printer, a Light Emitting Diode (LED) printer, an impact printer, a Dot-matrix printer, a solid ink printer, a dye sublimation printer, a portable printer, a plotter, a digital photo printer, a multi-function printer, a label printer, a 3 dimensional printer, and/or a variety of other printers known in the art. In an embodiment, the printing device 200 is operable to print on a piece of media that may include, for example, 8×11 paper, A4 paper, transparencies, photo paper, and/or a variety of other printable media known in the art. In an embodiment, the printing device 200 may include automatic document feeders (not shown) known in the art for automatically providing a document to the printing device 200.

The printing device 200 includes a rejected media holder 202, a new media holder 204, a used media holder 206, and a printed media holder 208. The media holders 202, 204, 206 and 208 may each be, for example, trays, cartridges, slots defined by a printing device chassis 209, and/or a variety of other media holding and/or storage devices known in the art. A plurality of scan path movers 210a, 210b and 210c define a scan path that is located adjacent a scan module 212. In an embodiment, the scan path movers 210a, 210b and 210c include devices known in the art that are operable to move media through a printing device. In an embodiment, the scan module 212 may include a conventional scanning device known in the art that is operable to detect the existence of printing on a piece of media. In an embodiment, the scan module 212 is a single scan module. In an embodiment, the scan module 212 is a plurality of scan modules. In an embodiment, the scan module 212 includes a processor, for example, by being coupled to the processor 102 located in the IHS 100 described above with reference to FIG. 1, by being coupled to a processor located in the printing device 200, and/or by including a processor that is integral to the scan module 212. A media directing device 214 is located adjacent the scan path movers 210c. A print path directing member 216a is located adjacent the media directing device 214. The print path directing member 216a and a plurality of print path movers 216b, 216c and 216d define a print path that is located adjacent a print module 218. In an embodiment, the print path directing member 216a may include devices (not illustrated) for moving media along the print path directing member 216a. In an embodiment, the print path movers 216b, 216c and 216d include devices known in the art that are operable to move media through a printing device. In an embodiment, the print module 218 may include a conventional printing device known in the art that is operable to print on a piece of media. A duplexing/rejected media path directing member 220a is located adjacent the media directing device 214. The duplexing/rejected media path directing member 220a and a plurality of duplexing/rejected media path movers 220b and 220c define a duplexing/rejected media path from the media directing device 214 to a media directing device 222 that is located adjacent the duplexing/rejected media path movers 220c. In an embodiment, the duplexing/rejected media path directing member 220a may include devices (not illustrated) for moving media along the duplexing/rejected media path directing member 220a. In an embodiment, the duplexing/rejected media path movers 220b and 220c include devices known in the art that are operable to move media through a printing device. A plurality of rejected media path movers 224 defined a rejected media path between the media directing device 222 and the rejected media holder 202. In an embodiment, the rejected media path movers 224 include devices known in the art that are operable to move media through a printing device. A duplexing media path directing member 226 is located adjacent the media directing device 222. The duplexing path directing member 226 and a duplexing media path mover 228 define a duplexing media path from the media directing device 222 to a point along the scan directing path. In an embodiment, the duplexing path directing member 226 may include devices (not illustrated) for moving media along the duplexing path directing member 226. In an embodiment, the duplexing media path mover 228 includes a device known in the art that is operable to move media through a printing device. In an embodiment, the media directing device 214, the duplexing/rejected media path directing member 220a, the duplexing/rejected media path movers 220a and 220c, the media directing member 222, the duplexing media path directing member 226, and the duplexing media path mover 228 may be referred to as a duplex module and are operable to perform a duplex operation, described below, to reverse the side of a piece of media that is presented to the scan module 212. In an embodiment, the duplex module may be a common duplex module for both scanning and printing functions.

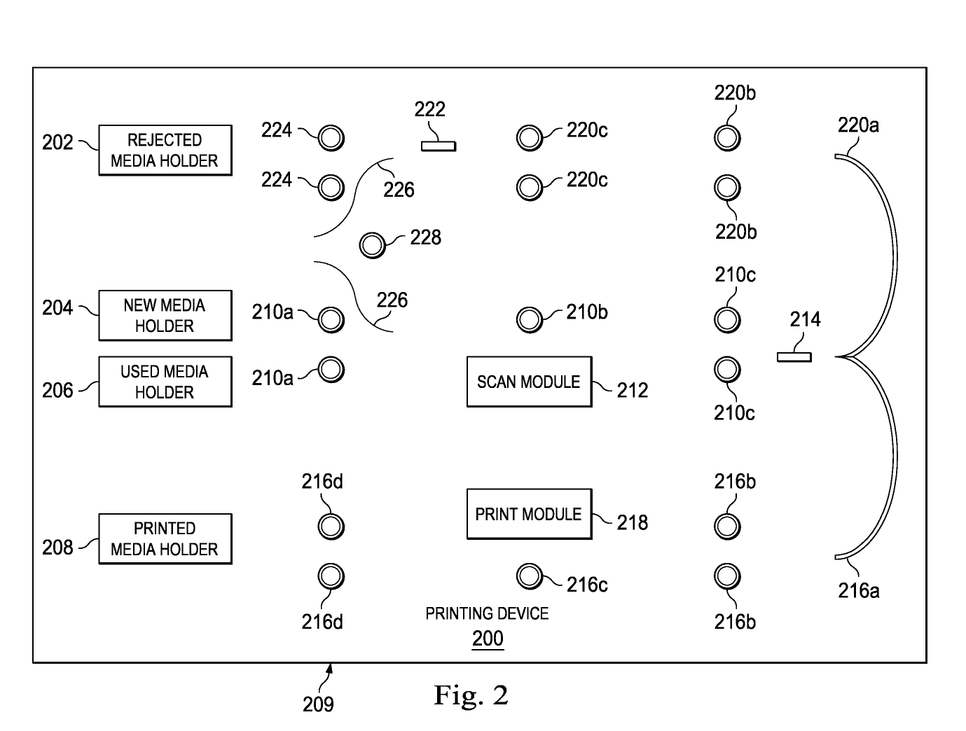

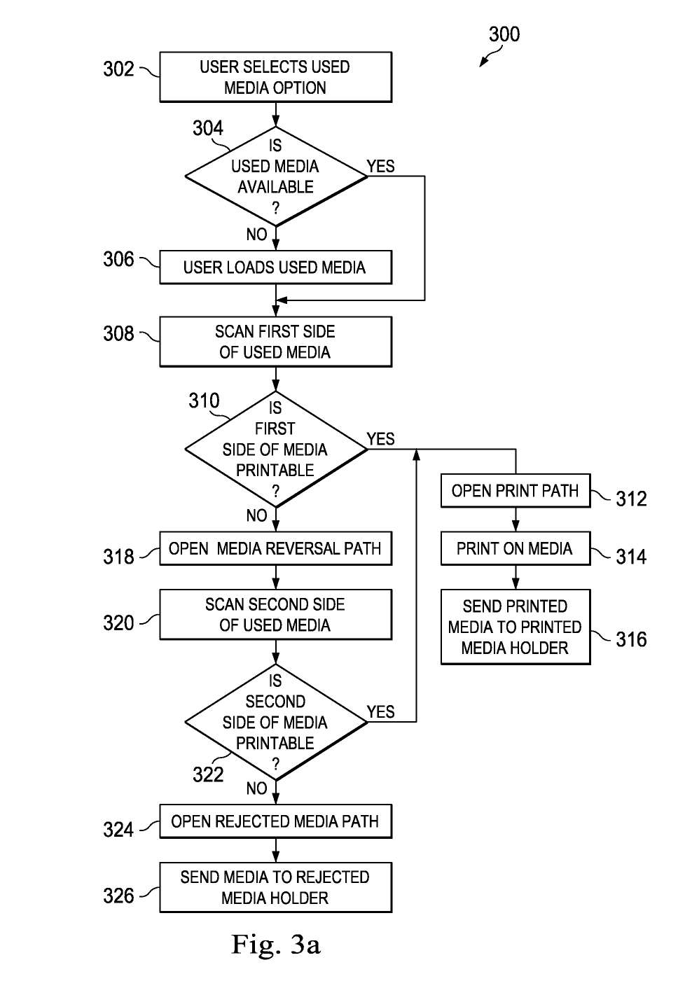

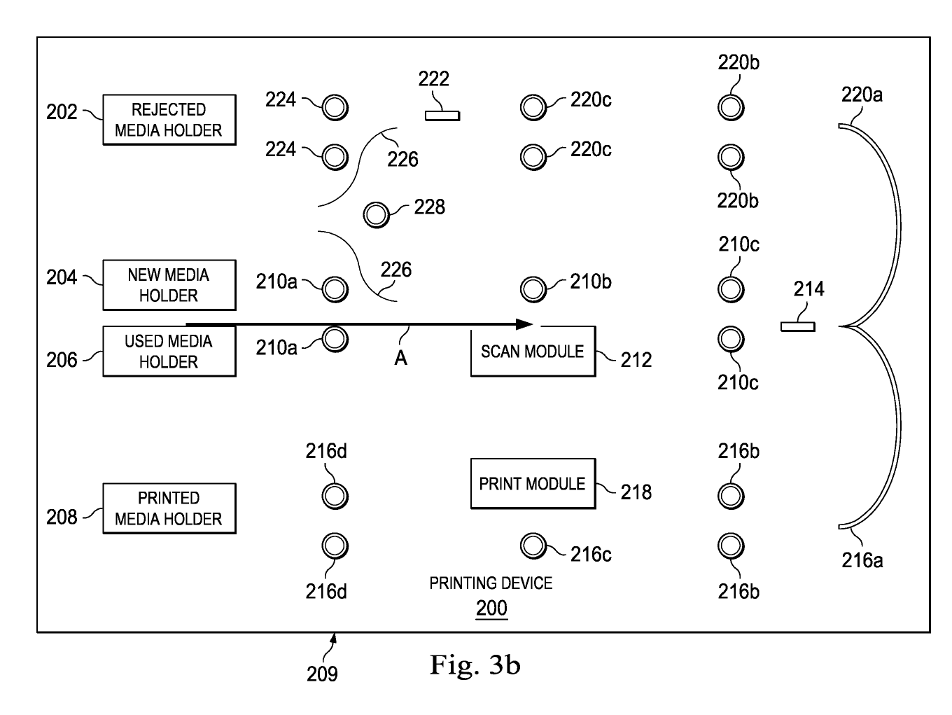

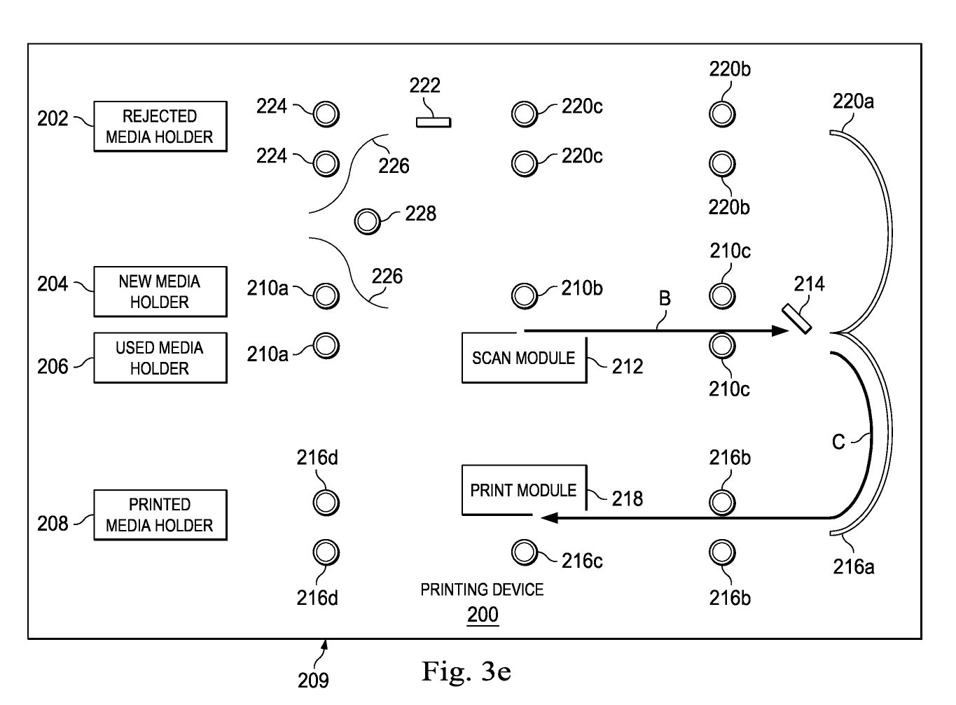

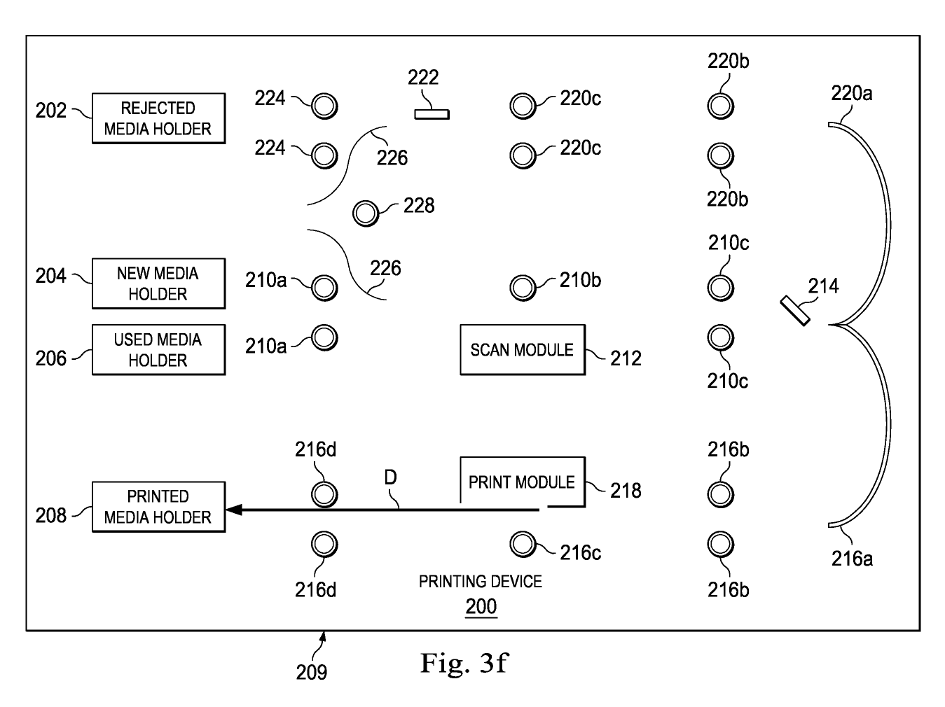

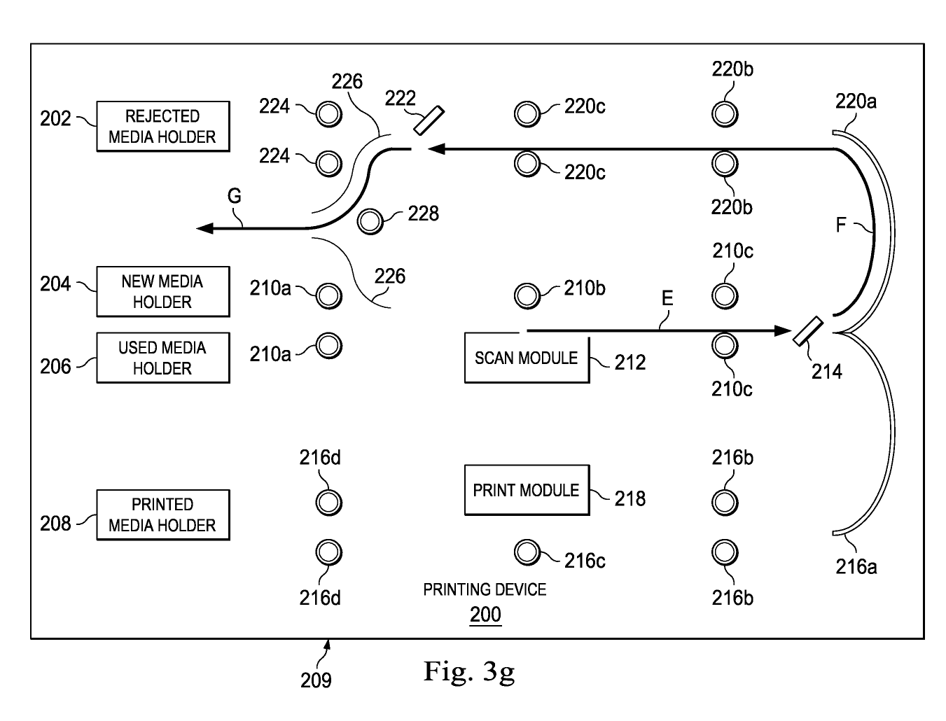

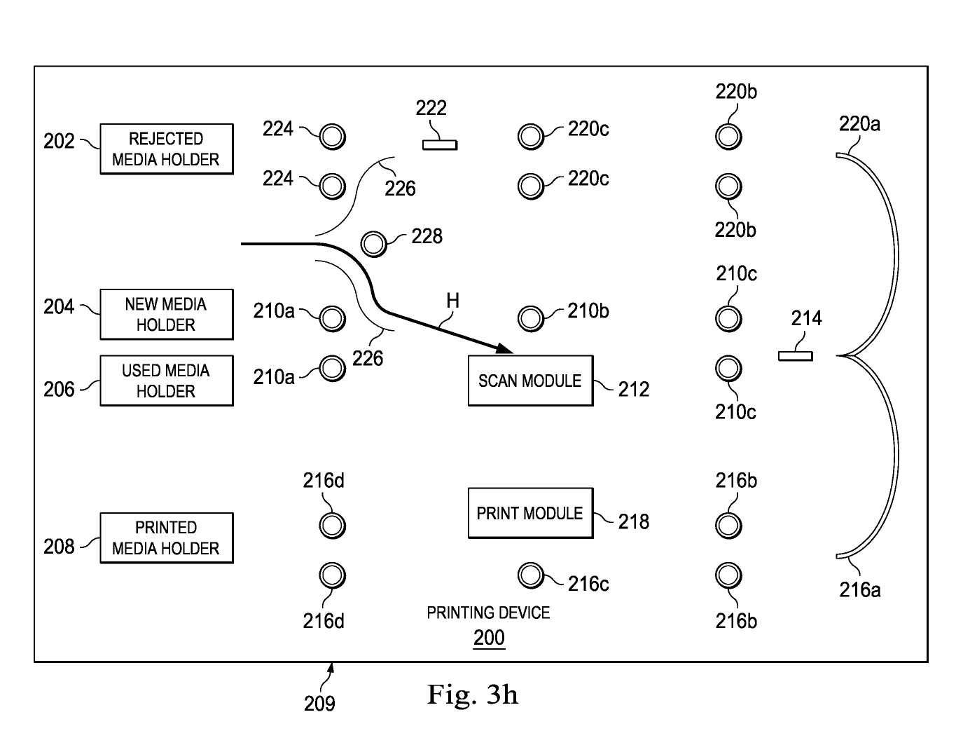

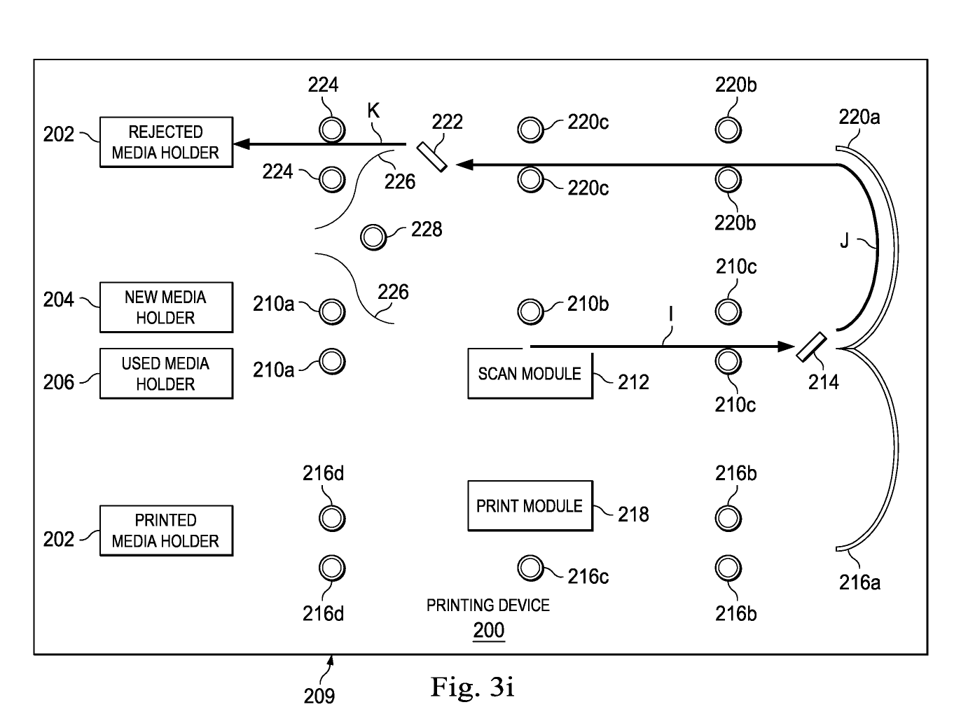

Referring now to FIGS. 2, 3a, 3b, 3c and 3d, a method 300 for used media printing is illustrated. The method 300 begins at block 302 where a user of the printing device 200 selects a used media option to print on used media using the printing device 200. In an embodiment, the printing device 200 includes a media selector that is coupled to the printing device 200 and that allows a user of the printing device 200 to indicate which of the new media holder 204 and the used media holder 206 the printing device 200 should access to obtain media for printing. In an embodiment, the new media holder 204 includes a plurality of pieces of new media. In an embodiment, new media may include, for example, blank 8×11 paper, blank A4 paper, blank transparencies, blank photo paper, and/or a variety of other printable media known in the art that has not been previously printed on. In an embodiment, new media may include some printing such as, for example, in the case of letterhead, watermarked media, and/or a variety of other pre-printed media known in the art that includes printing meant to be included on anything subsequently printed on that media (e.g., a company name, company information, a company logo, and a variety of other pre-printed material known in the art.) In an embodiment, new media may include media that has not been printed on subsequent to the purchase of the media for use in the printing device 200. In an embodiment, the used media holder 206 includes a plurality of pieces of used media. In an embodiment, used media may include, for example, previously printed upon 8×11 paper, previously printed upon A4 paper, previously printed upon photo paper, and/or a variety of other printable media known in the art that has been previously printed upon. In an embodiment, used media may include media that has been printed on subsequent to the purchase of the media for use in the printing device 200. In an embodiment, used media may include media that has been previously printed upon on only one side of the used media. In an embodiment, used media may include media that has been previously printed upon on both sides of the used media. In an embodiment, each piece of the plurality of used media in the used media holder 206 may be in a first orientation, with a printed side of the used media facing a first direction, or in a second orientation, with a printed side of the used media facing a second direction that is opposite the first direction, as will be described in further detail below. For example, the user of the printing device 200 may collect a plurality of pieces of used media in different orientations and place them in the used media holder 206 without sorting them.

Upon the user of the printing device 200 using the media selector to select a used media option, the method 300 proceeds to decision block 304 where the method 300 determines whether used media is available. In an embodiment, the printing device 200 may include a sensor located, for example, in the used media holder 206, in order to detect whether used media is located in the used media holder 206. If there is no used media located in the used media holder 206, the method 300 proceeds to block 306 where the printing device 200 and/or the IHS 100 prompts the user to load used media in the used media holder 206 and detects when the user does so. If, at decision block 304, the method 300 determines there is used media in the used media holder 206, or after the user loads used media into the used media holder 206 in block 306 of the method 300, the method 300 then proceeds to block 308 where a first side of the used media is scanned.

The printing device 200 takes a piece of used media from the used media holder 206 and moves the piece of used media along the scan path designated by the arrow A using the scan path movers 210a and 210b to move a first side of the piece of used media adjacent the scan module 212. The method 300 then proceeds to decision block 310 where the method 300 determines whether the first side of the piece of used media is printable. As the first side of the piece of used media is moved by the scan module 212, the scan module 212 scans the first side of the piece of used media to determine the amount of printing on the first side of the piece of used media in order to determine whether that piece of used media is printable. In an embodiment, scan data from the scan module 212 is sent to a processor that determines the amount of printing on the first side of the piece of used media. In a embodiment, the first side of the used media is printable if the scan module 212 and/or processor determine that the first side of the piece of used media includes less than a predetermined amount of printing. For example, the scan module 212 and/or processor may determine that the first side of the piece of used media is printable if the first side of the piece of used media is blank (i.e. there is no printing on the first side of the piece of used media.) In another example, the scan module 212 and/or processor may determine that the first side of the piece of used media 310a is printable if a first side 310aa of the piece of used media 310a includes a non-printed-on section 310ab that is blank (i.e. there is no printing in the section 310ab on the first side 310aa of the piece of used media 310a), illustrated in FIG. 3c. In another example, the scan module 212 and/or processor may determine that the first side of the piece of used media 310b is printable if a first side 310ba of the piece of used media 310b includes a non-printed-on section 310bb that is blank (i.e. there is no printing in the section 310bb), illustrated in FIG. 3d. In an embodiment, the scan module 212 and/or processor may determine that the first side of the piece of used media is printable if the printing on the first side of the piece of used media is less than a predetermined percentage of the total printable area on the first side of the piece of used media (e.g., the first side of the piece of used media is white, and first side of the piece of used media is printable if less than 5% of the first side of the piece of used media includes non-white printing). In an embodiment, the predetermined percentage may be set by a user of the printing device 200. In an embodiment, the user of the printing device 200 may define any section on the piece of used media as a scanning section, similar to the non-printed-on sections illustrated in FIGS. 3c and 3d, and the scan module 212 and/or processor may determine whether that scanning section is printable. While a number of examples have been provided, one of skill in the art will recognize that a variety of additional criteria may be used to determine whether a particular section of the used media is printable.

Referring now to FIGS. 2, 3a, 3e and 3f, if, at decision block 310, the method 300 determines that the first side of the piece of used media is printable, the method 300 proceeds to block 312 where a print path is opened. When the scan module 212 and/or processor determine that the first side of the piece of used media is printable, a signal is sent to the media directing device 214 to move the media directing member 214 into a print path orientation, illustrated in FIG. 3e, and the piece of used media is moved along the scan path designated by the arrow B using the scan path movers 210c until the piece of used media is directed by the media directing member 214 to the print path directing member 216a. The method 300 then proceeds to block 314 where the first side of the piece of used media is printed on. The used media is moved along a print path designated by the arrow C using the print path directing member 216a and the print path movers 216b and 216c until the used media is located adjacent the print module 218. The print module 218 may then be used to print on the first side of the piece of used media. In an embodiment, the print module 218 may print on a printable section of the first side of the piece of used media, discussed above with reference to decision block 310. The method 300 then proceeds to block 316 where the used media, which is now printed media, is sent to the printed media holder 208. The used/printed media is moved along a print path designated by the arrow D using the print path movers 216d until the used media is located in the printed media holder 208.

Referring now to FIGS. 2, 3a, 3g and 3h, if, at decision block 310, the method 300 determines that the first side of the piece of used media is not printable, the method 300 proceeds to block 318 where a media duplexing path is opened. When the scan module 212 and/or processor determine that the first side of the piece of used media is not printable, a signal is sent to the media directing device 214 and the media directing member 222 to move into a duplexing path orientation, illustrated in FIG. 3g, and the piece of used media is moved along the scan path designated by the arrow E using the scan path movers 210c until the piece of used media is directed by the media directing member 214 on to the duplexing/rejected media path directing member 220a. The used media is then moved along a duplexing/rejected media path designated by the arrow F using the duplexing/rejected media path directing member 220a and the duplexing/rejected media path movers 220b and 220c until the used media is located adjacent the media directing member 222. The piece of used media is then directed by media directing member 222 onto the duplexing path directing member 226 and moved along a forward duplexing path designated by the arrow G using the duplexing path directing member 226 and the duplexing media path mover 228, illustrated in FIG. 3g. The piece of used media is then moved along a reverse duplexing path designated by the arrow H using the duplexing path directing member 226 and the duplexing media path mover 228 until the piece of used media enters the scan path adjacent the scan module 212, illustrated in FIG. 3h. The method 300 then proceeds to block 320 where a second side of the used media is scanned. Due to the movements of the piece of used media through the forward duplexing path designated by the arrow G and the reverse duplexing path designed by the arrow H, when the piece of used media enters the scan path, the second side of the piece of used media is presented to the scan module 212 to scan in substantially the same manner as the first side of the piece of used media was scanned, as described above with reference to block 308.

Referring now to FIGS. 2, 3a, 3e, 3f and 3i, the method 300 then proceeds to decision block 322 where the method 300 determines whether the second side of the used media is printable. In an embodiment, determining whether the second side of the piece of used media is printable is substantially similar to the determining whether the first side of the piece of used media is printable, described above with reference to decision block 310. If the method 300 determines that the second side of the piece of used media is printable, the method 300 proceeds to blocks 312, 314 and 316, described above. If the method 300 determines that the second side of the piece of used media is not printable, the method 300 proceeds to block 324 where a rejected media path is opened. When the scan module 212 and/or processor determine that the second side of the piece of used media is not printable, a signal is sent to the media directing device 214 and the media directing member 222 to move into a rejected media path orientation, illustrated in FIG. 3i. The method 300 then proceeds to block 326 where the piece of used media is sent to the rejected media holder 202. The piece of used media is moved along the scan path designated by the arrow I using the scan path movers 210c until the piece of used media is directed by the media directing member 214 to the duplexing/rejected media path directing member 220a. The used media is then moved along the duplexing/rejected media path designated by the arrow J using the duplexing/rejected media path directing member 220a and the duplexing/rejected media path movers 220b and 220c until the used media is located adjacent the media directing member 222. The piece of used media is then directed by media directing member 222 such that it moves along the rejected media path designated by the arrow K using the rejected media path movers 224 until the piece of used media is located in the rejected media holder 202.

Thus, a printing device is disclosed that allows a user of the printing device to print on used media without the need for sorting the used media to properly orient a printable side of the used media for printing. Furthermore, one of skill in the art will recognize how a piece of new media may be moved by the printing device 200 from the new media holder to the print module 218 to print on a first side of the piece of new media, and then either sent to the printed media holder 208 or reversed using, for example, the duplex module, such that the print module 218 may print on a second side of the piece of new media. One of skill in the art will also recognize that the scan module 212 may scan a document, send that scanned document to a media holder, save the data from the scan, and/or use the print module 218 to print a copy of that document on new or used media. Finally, the structure disclosed above is merely exemplary, and one of skill in the art will recognize that a number of different structures and devices may be used to accomplish the functions described above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A printing device, comprising:
a used media holder;
a scan module that is operable to receive a piece of used media from the used media holder and determine whether the piece of used media comprises a printable side; and
a print module that is operable to receive the piece of used media from the scan module, wherein in response to the scan module determining that the piece of used media includes a printable side, the print module is operable to print on the printable side.

2. The printing device of claim 1, wherein a printable side on the piece of used media is a side on the piece of used media that comprises less than a predetermined amount of printing.

3. The printing device of claim 1, wherein the scan module being operable to determine whether the piece of used media is printable comprises the scan module being operable to determine whether a first side of the piece of used media comprises a printable side and the scan module being operable to determine whether a second side of the piece of used media comprises a printable side.

4. The printing device of claim 3, further comprising:
a duplex module, wherein in response to the scan module determining that the first side of the piece of used media does not comprise a printable side, the duplex module is operable to present the second side of the piece of used media to the scan module.

5. The printing device of claim 1, further comprising:
a rejected media holder, wherein in response to the scan module determining there is not a printable side on the piece of used media, the rejected media holder is operable to receive the piece of used media.

6. The printing device of claim 1, further comprising:
a printed media holder that is operable to receive a piece of printed media from the print module.

7. The printing device of claim 1, further comprising:
a new media holder, wherein the print module is operable to receive a piece of new media from the new media holder.

8. The printing device of claim 7, further comprising:
a media selector coupled to the printing device and operable by a user of the printing device to select media from one of the used media holder and the new media holder for use in the printing device.

9. An information handling system, comprising:
a processor;
a storage coupled to the processor;
a scan module that is coupled to the processor and operable to scan a piece of used media such that the processor may determine whether the piece of used media comprises a printable side; and
a print module that is coupled to the processor and operable to receive the piece of used media from the scan module, wherein in response to the processor determining that the piece of used media includes a printable side, the print module is operable to print on the printable side.

10. The system of claim 9, wherein a printable side on the piece of used media is a side on the piece of used media that comprises less than a predetermined amount of printing.

11. The system of claim 9, wherein the scan module being operable to scan the piece of used media comprises the scan module being operable to scan a first side of the piece of used media such that the processor may determine whether the first side of the piece of used media comprises a printable side and the scan module being operable to scan a second side of the piece of used media such that the processor may determine whether second side of the piece of used media comprises a printable side.

12. The system of claim 11, further comprising:
a duplex module, wherein in response to the processor determining that the first side of the piece of used media does not comprise a printable side, the duplex module is operable to present the second side of the piece of used media to the scan module.

13. The system of claim 9, further comprising:
a printed media holder that is operable to receive a piece of printed media from the print module.

14. The system of claim 9, further comprising:
a rejected media holder, wherein in response to the processor determining there is not a printable side on the piece of used media, the rejected media holder is operable to receive the piece of used media.

15. The system of claim 9, further comprising:
a used media holder, wherein the scan module is operable to receive the piece of used media from the used media holder.

16. The system of claim 15, further comprising:
a new media holder, wherein the print module is operable to receive a piece of new media from the new media holder.

17. The system of claim 16, further comprising:
a media selector that is coupled to the processor and operable by a user to select media from one of the used media holder and the new media holder.

18. A method for used media printing, comprising:
scanning a piece of used media;
determining whether the piece of used media comprises a printable side; and
printing on the printable side of the used media in response to determining that the piece of used media includes the printable side.

19. The method of claim 18, wherein the determining whether the piece of used media comprises a printable side comprises one of scanning a first side of the piece of used media and determining that the first side comprises a printable side and scanning a second side of the piece of used media and determining that the second side comprises a printable side.

20. The method of claim 18, further comprising:
sending the piece of used media to a rejected media tray in response to determining that the piece of used media does not comprise a printable side.
